(19) United States
(12) Patent Application Publication
(10) Pub. No.: US 2005/0275742 A1
(43) Pub. Date: Dec. 15, 2005

(54) Autofocus after image capture

(76) Inventor: John M. Baron, Longmont, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/865,594

(22) Filed: Jun. 9, 2004

(51) Int. Cl. H04N 5/232; G03B 13/00; G03B 17/00

(52) U.S. Cl. 348/345; 396/77

(57) ABSTRACT

A method of focusing an imaging device includes initiating a continuous automatic focusing operation after an image has been captured by the imaging device, and terminating the continuous automatic focusing operation after a predetermined period of time has elapsed after the image has been captured.

### BACKGROUND

Many different types of imaging devices exist for capturing images. Imaging devices convert light reflected from a scene to some viewable and storable format. For example, a digital camera may include an electronic photodetector like a charge-coupled device (CCD) to convert light to electronic signals representative of a scene, and a film camera may expose a chemically coated film to light reflected from a scene. In the case of the digital camera, the electrical signals may be processed and the resulting image may be displayed on an electronic display and stored on digital media. In the case of the film camera, the film may be developed and used to print images on photographic paper.

Although some imaging devices have a fixed focus, most imaging devices include some variable focus system for focusing the image, such as a lens system which focuses incoming light on whatever imaging element is used. A typical lens system in an imaging device includes one or more lenses which may be moved to adjust the distance between themselves and the imaging element, thereby focusing incoming image light on the imaging element.

Several typical automatic focusing techniques exist for imaging devices, including active and passive focusing. Active focusing involves transmitting energy in some form, such as infrared light, from the imaging device onto a focus object, and receiving reflections from the focus object to determine the distance from the imaging device to the focus object. The lens system in the imaging device can then be set to the proper focus position according to that distance.

Passive focusing involves capturing consecutive images while adjusting the lens system in the imaging device and comparing the images to determine when the imaging device is properly focused. For example, a digital camera using passive focusing may search for the focus position that results in the maximum intensity difference between adjacent pixels in an image.

Although some focusing techniques are faster than others, all introduce some delay into the image capture process which may be noticeable to the user and which may result in unfocused images or the inability to capture an image at the desired instant. Various techniques have been devised to address this problem. For example, some imaging devices include a two-stage shutter release button. When the shutter release button is pressed down partially, the imaging device focuses on the subject, and maintains that focus, until the shutter release button is pressed down fully to capture the image. This enables a photographer to pre-focus the imaging device in anticipation of a desired instant. This does not, however, help to minimize delays between capturing successive images.

Another technique which does minimize focusing delays when capturing successive images is to continually focus the imaging device, rather than just when the shutter release button is pressed. However, this technique requires a great deal of power and therefore minimizes battery life in portable imaging devices.

### SUMMARY

An exemplary embodiment may comprise a method of focusing an imaging device, including initiating a continuous automatic focusing operation after an image has been captured by the imaging device, and terminating the continuous automatic focusing operation after a predetermined period of time has elapsed after the image has been captured.

Another exemplary embodiment may comprise a method of capturing a plurality of images in an imaging device, including automatically focusing the imaging device, capturing a first image, continuing to automatically focus for a predetermined period of time after capturing the first image, and capturing a second image.

Another exemplary embodiment may comprise an apparatus for focusing an imaging device, the apparatus including at least one computer readable medium having computer readable program code stored thereon. The computer readable program code includes program code for capturing an image in the imaging device, and program code for continually automatically focusing the imaging device during a predetermined period of time after capturing the image.

Another exemplary embodiment may comprise an imaging apparatus, including a lens system, a focus motor connected to the lens system for automatically focusing the lens system, and a control system connected to the focus motor. The control system is adapted to automatically adjust the focus motor to maintain a focused condition for a predetermined period after an image is captured by the imaging device.

Another exemplary embodiment may comprise an imaging apparatus. The apparatus includes means for capturing an image, means for continuously automatically focusing the imaging apparatus, and means for activating the continuously automatically focusing means for a predetermined period of time after the capturing means captures the image.

### BRIEF DESCRIPTION OF THE DRAWINGS

Illustrative embodiments are shown in the accompanying drawings, in which:

FIG. 1 is an isometric front view illustration of an exemplary embodiment of an imaging device with an adjustable-focus lens;

FIG. 2 is an isometric rear view illustration of the exemplary embodiment of the electronic imaging device of FIG. 1;

FIG. 3 is a block diagram of an exemplary embodiment of an electronic imaging device; and

FIG. 4 is a flow chart of an exemplary operation for focusing an imaging device.

### DESCRIPTION

The drawings and description, in general, disclose a method and apparatus for automatically focusing an imaging device which may substantially minimize shot-to-shot delays caused by focusing. The imaging device may comprise any type of imaging device, such as a film camera or a digital camera, which includes any automatic focus system, such as passive focusing or active focusing.

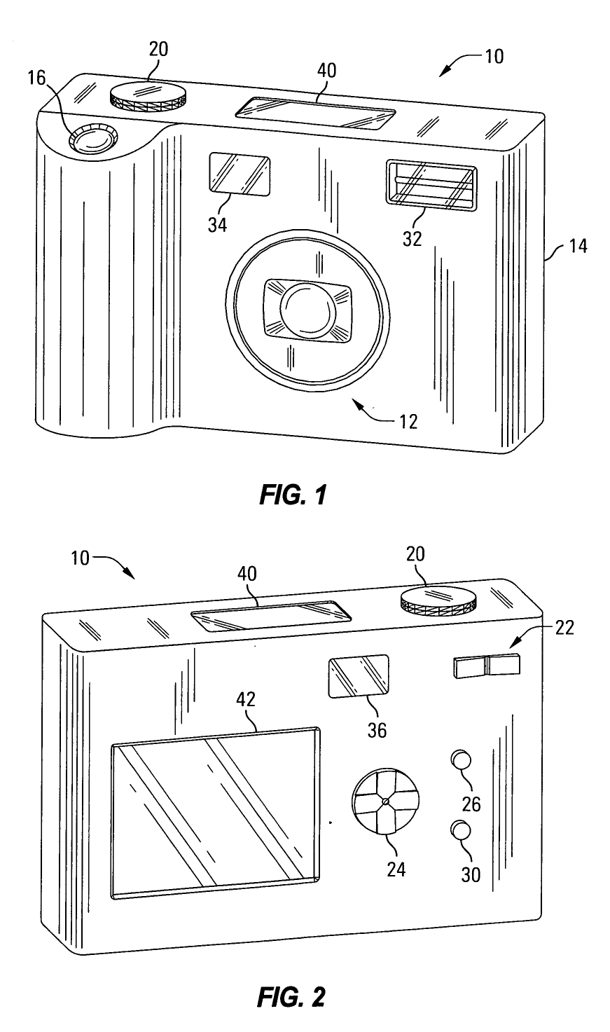

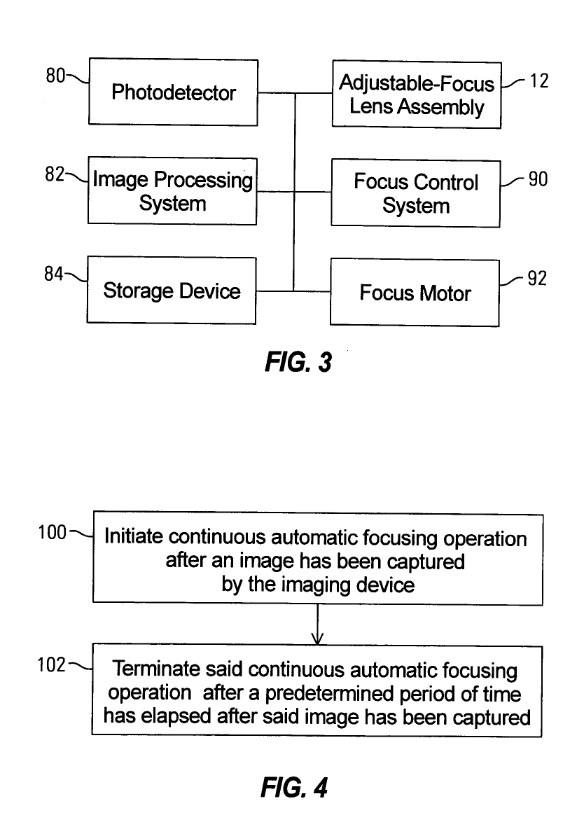

Before describing the focusing method in more detail, an exemplary digital camera in which the focusing method may be applied will be described. Referring now to FIGS. 1 through 3, an exemplary digital camera 10 comprises a housing portion or body 14 which is sized to receive the various systems and components required by the digital camera 10. For example, in the embodiment shown and described herein, the body 14 is sized to receive an adjustable-focus lens assembly 12, a photodetector 80, a storage device 84 to store the image data collected by the photodetector 80, and an image processing system 82 to process and format the image data. The photodetector 80 may comprise any suitable detector, such as a charge-coupled device (CCD). The adjustable-focus lens assembly 12 is located in the body 14 to allow light to enter the digital camera 10. The body 14 may also be sized to receive a power source such as a battery.

Control buttons such as a shutter release button 16, a mode dial 20, a zoom control switch 22, and others (e.g., 24, 26, and 30) as needed are provided on the outside of the body 14. The digital camera 10 may include an illumination system such as a flash 32 mounted on the outside of the body 14. Viewfinder windows 34 and 36 and display devices 40 and 42 are also located on the outside of the body 14. Each of the foregoing systems and devices will now be described.

Image light enters the digital camera 10 through the adjustable-focus lens assembly 12. The photodetector 80 detects the image light focused thereon by the adjustable-focus lens assembly 12.

The term image light as used herein refers to the light, visible or otherwise, that is focused onto the surface of the photodetector by the adjustable-focus lens assembly 12. The image light may be converted into digital signals in essentially three steps. First, each pixel in the photodetector converts the light it receives into an electric charge. Second, the charges from the pixels are amplified by an analog amplifier. Finally, the amplified analog charges are digitized by an analog-to-digital (A/D) converter, representing the voltage level of the amplified charges with a number. The digital data then may be processed and/or stored as desired.

A storage device 84 is located in the body 14 of the digital camera 10 to store the image data captured by the photodetector 80. The storage device 84 comprises any suitable type of memory, such as a removable rewriteable non-volatile memory, random access memory (RAM), or any other magnetic, optical, or other solid state storage medium.

An image processing system 82 is located in the body 14 of the digital camera 10 to process and format the image data, either before or after storage in the storage device 84. The image processing system 82 may comprise a microprocessor and associated memory. Alternatively, the image processing system 82 may comprise a hard-coded device such as an application specific integrated circuit (ASIC). The image processing system 82 processes image data to scale images for display on a graphical display device 42, among other tasks. For example, the image processing system 82 may also perform filtering and de-mosaic functions.

A focus control system 90 and focus motor 92 are provided in the digital camera 10 as will be described below. The focus control system 90 may be implemented by the same microprocessor or hard-coded device as the image processing system 82, or may be a separate component in the digital camera 10, such as a microprocessor and memory, ASIC, state machine and programmable read-only-memory (PROM), etc. Program code in the focus control system 90 for directing the passive autofocus process may comprise firmware code stored in a memory, or may be hard-coded in the control system 90, or may be implemented in any other suitable and desired manner.

The graphical display device 42 comprises a liquid crystal display (LCD) or any other suitable display device. An alphanumeric display device 40 on the digital camera 10 also comprises an LCD or any other suitable display device, and is used to indicate status information, such as the number of images which can be captured and stored in the storage device 84, and the current mode of the digital camera 10.

The digital camera 10 may also include other components, such as an audio system. However, because digital cameras are well-known in the art and could be provided by persons having ordinary skill in the art after having become familiar with the teachings of the present invention, the digital camera 10 utilized in one embodiment of the present invention, as well as the various ancillary systems and devices (e.g., battery systems and storage devices) that may be utilized in one embodiment of the present invention will not be described in further detail herein.

During operation of the digital camera 10, the digital camera 10 is turned on and off by one of the control buttons such as the mode dial 20, and a mode is selected, such as a single or multiple exposure mode. The digital camera 10 is oriented with the adjustable-focus lens assembly 12 directed at a subject. The subject may be monitored either through a viewfinder 34 and 36, or on the graphical display panel 42. If the adjustable-focus lens assembly 12 is a zoom lens, the focal length is adjusted by pressing a control button such as the zoom control switch 22.

As the shutter release button 16 is pressed, the autofocus process is initiated by the focus control system 90, and focus lens elements in the adjustable-focus lens assembly 12 are adjusted to focus image light onto the photodetector 80. The flash 32 illuminates the subject, if needed. The photodetector 80 then converts the image light directed thereon by the adjustable-focus lens assembly 12 into electrical image data, which are stored in the storage device 84. The image processing system 82 then processes the image data and displays the captured image on the display device 42.

In one exemplary embodiment of the method and apparatus for automatically focusing an imaging device which may substantially minimize shot-to-shot delays caused by focusing, the autofocus process is continued for a predetermined amount of time in the imaging device after the image has been captured. The imaging device thus maintains a focused state during this predetermined period, thereby enabling images to be captured in rapid succession without requiring that the imaging device be refocused from a default focus position before each image is captured. For example, the imaging device may continue to automatically focus for several seconds after an image has been captured. If another image is to be captured shortly thereafter, the imaging device may use the last focus position left when the autofocus process ended, or may use that last focus position as a starting point for an autofocus operation before the image is captured, thereby eliminating or reducing the amount of focusing required before the latter image is captured. As the imaging device is moved about after an image is captured, or as the scene changes before the imaging device, the focus is maintained and updated for the predetermined period so that subsequent images may be captured rapidly and in focus without waiting for a full autofocus operation to be performed. Terminating the autofocus operation after the predetermined period reduces the power usage, extending battery life.

The continuation of the autofocus process after image capture may be performed using any suitable autofocus technique, as discussed above. For example, it may comprise a true continuous autofocus in which the lens is continually being focused. Alternatively, it may comprise an ongoing periodic autofocus technique in which a focus position is used as a starting point and the focus position is refined from there in a series of focus adjustments. The term “continuous autofocus” is used herein to refer to any of these or other suitable autofocus techniques, whether truly continuous, periodic, or otherwise, as long as it is an ongoing process after image capture until the autofocus process is concluded.

The method and apparatus for automatically focusing disclosed herein, in which an autofocus process is continued for a brief period of time after an image is captured, is not limited to use with any particular type of imaging device, nor with any particular type of autofocus system. For example, it may be applied to digital or film still cameras, to various active or passive focusing algorithms, etc.

The predetermined period during which the amount of time may be set at any length desired, taking into consideration factors such as battery life and power drain during autofocusing, the need to maintain focus for rapid series of images, etc. In one exemplary embodiment, the predetermined period is fixed at the time of manufacture, either by hard-wiring the duration, or by including it in firmware in a focus control system 90 in the imaging device. In another exemplary embodiment, the predetermined period may be set by the photographer. In yet another exemplary embodiment, the predetermined period may be affected by the imaging device mode setting selected using the mode dial 20, extending the predetermined period when capturing sporting events or portraits, and reducing the predetermined period when capturing landscape images.

In one exemplary embodiment, the imaging device comprises a digital camera 10 which operates as follows to implement autofocus after image capture. (Note that the camera modes and predetermined period durations are purely exemplary and may be adapted as desired.) The mode dial 20 on the digital camera 10 is used to turn on the digital camera 10 in standard still image mode. Firmware in the digital camera 10 sets the predetermined period for autofocus after image capture at 5 seconds. When the photographer presses the shutter release button 16 down halfway (to an “S1” position), the digital camera 10 begins automatically focusing until a satisfactory focus position is found for the adjustable-focus lens assembly 12, using any suitable determination. The digital camera 10 then terminates the autofocus process and maintains this focus position as long as the shutter release button 16 is held at the S1 position. When the photographer then presses the shutter release button 16 all the way down (to an “S2” position), the digital camera 10 captures the image from the photodetector 80 and stores it in the storage device 84.

The digital camera 10 then begins the autofocus process again and starts an electronic timer to enable the digital camera 10 to determine when the predetermined period elapses after capturing the image. For example, the timer may comprise a countdown timer set to the predetermined period, or a time stamp that is checked against a current time in a control code loop to. In an alternative embodiment, the timer may comprise an analog delay element such as a capacitor that discharges over time to establish the predetermined period, or even a mechanical timer. During this predetermined period, the digital camera 10 continues to automatically focus the adjustable-focus lens assembly 12, even if the shutter release button 16 is not being pressed.

If the shutter release button 16 is pressed to position S1 and held, the digital camera 10 may terminate the autofocus process as soon as a suitable focus position is found and will hold the focus position as long as the shutter release button 16 is in position S1. If the shutter release button 16 is pressed to position S2, the second image is captured. If the shutter release button 16 is pressed directly through position S1 to position S2 during the predetermined period while the autofocusing process is ongoing, the digital camera 10 may either proceed directly to image capture or may determine whether the focus position is acceptable or whether additional focusing is needed before capturing the second image. The digital camera 10 may thus either capture the image using the current focus position left by the autofocusing process, or may continue to autofocus until the digital camera 10 is focused. The digital camera 10 may alternatively use a previous focus position, the last known good focus position, either because it appears that the current focus position is far from correct, or because it appears that the current focus position is very close to the last known good focus position.

The predetermined period is restarted when the second image is captured. (Note that another description of this terminating and restarting of predetermined periods is that one predetermined period is simply extended, and that these are simply two descriptions of one functionally equivalent operation.)

If the predetermined period after the first image elapses without the shutter release button 16 being pressed, the digital camera 10 terminates the automatic focusing process. In one exemplary embodiment, the adjustable-focus lens assembly 12 is left in the last focus position found by the automatic focusing process, to be used either as the focus position for a subsequent image or as a starting point for automatically focusing for the subsequent image. In the latter case, when the shutter release button 16 is again pressed to position S1, the digital camera 12 begins the autofocus process again from the last focus position until a suitable focus position is found. Because the adjustable-focus lens assembly 12 was left in the last focus position by the autofocus process during the predetermined period, the time required to find the suitable focus position is likely reduced.

Alternatively, the adjustable-focus lens assembly 12 may be returned to a default focus position at the end of the predetermined period so that any subsequent focusing and image capture operation begins from the default focus position.

If the mode dial 20 on the digital camera 10 is set in sports mode, the firmware in the digital camera 10 sets the predetermined period at 10 seconds, and the focusing and image capturing process may proceed as described above but with the longer predetermined period of automatic focusing after image capture.

The flow chart of FIG. 4 summarizes an exemplary operation for automatically focusing after image capture. The continuous automatic focusing operation is initiated 100 after an image has been captured by the imaging device, and is terminated 102 after a predetermined period of time has elapsed after the image has been captured. As discussed above, the automatic focusing operation may also be terminated during the predetermined period of time if the photographer captures a subsequent image during the predetermined amount of time.

An apparatus for automatically focusing after image capture may comprise at least one computer readable medium having computer readable program code stored thereon. The computer readable program code includes program code for capturing an image in the imaging device and program code for continually automatically focusing the imaging device during a predetermined period of time after capturing the image. The program code for capturing an image may be adapted to the particular imaging device. For example, the program code for capturing an image may comprise program code for releasing a shutter to expose film, or for gathering image data from an electronic photodetector, etc.

Various computer readable or executable code or electronically executable instructions have been referred to herein. These may be implemented in any suitable manner, such as software, firmware, hard-wired electronic circuits, or as the programming in a gate array, etc. Software may be programmed in any programming language, such as machine language, assembly language, or high-level languages such as C or C++. The computer programs may be interpreted or compiled.

Computer readable or executable code or electronically executable instructions may be tangibly embodied on any computer-readable storage medium or in any electronic circuitry for use by or in connection with any instruction-executing device, such as a general purpose processor, software emulator, application-specific circuit, a circuit made of logic gates, etc. that can access or embody, and execute, the code or instructions.

Methods described and claimed herein may be performed by the execution of computer readable or executable code or electronically executable instructions, tangibly embodied on any computer-readable storage medium or in any electronic circuitry as described above.

A storage medium for tangibly embodying computer readable or executable code or electronically executable instructions includes any means that can store, transmit, communicate, or in any way propagate the code or instructions for use by or in connection with the instruction-executing device. For example, the storage medium may include (but is not limited to) any electronic, magnetic, optical, or other storage device, or any transmission medium such as an electrical conductor, an electromagnetic, optical, infrared transmission, etc. The storage medium may even comprise an electronic circuit, with the code or instructions represented by the design of the electronic circuit. Specific examples include magnetic or optical disks, both fixed and removable, semiconductor memory devices such as memory cards and read-only memories (ROMs), including programmable and erasable ROMs, non-volatile memories (NVMs), optical fibers, etc. Storage media for tangibly embodying code or instructions also include printed media such as computer printouts on paper which may be optically scanned to retrieve the code or instructions, which may in turn be parsed, compiled, assembled, stored and executed by an instruction-executing device. The code or instructions may also be tangibly embodied as an electrical signal in a transmission medium such as the Internet or other types of networks, both wired and wireless.

While illustrative embodiments have been described in detail herein, it is to be understood that the concepts disclosed herein may be otherwise variously embodied and employed, and that the appended claims are intended to be construed to include such variations, except as limited by the prior art.

1. A method of focusing an imaging device, comprising:
initiating a continuous automatic focusing operation after an image has been captured by said imaging device;
terminating said continuous automatic focusing operation after a predetermined period of time has elapsed after said image has been captured.

2. The method of claim 1, wherein said initiation of said continuous automatic focusing operation is triggered by said capturing of said image.

3. The method of claim 1, wherein said continuous automatic focusing operation comprises a series of periodic focus adjustments.

4. The method of claim 1, wherein a focus position of said imaging device is maintained after said continuous automatic focusing operation has been terminated.

5. The method of claim 1, wherein a second image is captured by said imaging device after said image has been captured and before said predetermined period of time has elapsed, further comprising terminating said continuous automatic focusing operation before capturing said second image.

6. The method of claim 5, wherein said continuous automatic focusing operation is terminated after a focused condition is detected and before said capturing said second image.

7. The method of claim 5, wherein said continuous automatic focusing operation is terminated and a previous focus position is used for capturing said second image.

8. The method of claim 7, wherein said previous focus position is used because said imaging device determines that said continuous automatic focusing operation is at a focus position that is still out of focus by at least a predetermined amount when said second image is to be captured.

9. The method of claim 7, wherein said previous focus position is used because said imaging device determines that said continuous automatic focusing operation is at a focus position that is within a predetermined distance of said previous focus position when said second image is to be captured.

10. The method of claim 1, wherein a second image is captured by said imaging device after said image has been captured and after said predetermined period of time has elapsed, further comprising focusing said imaging device before capturing said second image, beginning from a focus position left by said continuous automatic focusing operation.

11. A method of capturing a plurality of images in an imaging device, comprising:
automatically focusing said imaging device;
capturing a first image;
continuing to automatically focus said imaging device for a predetermined period of time after capturing said first image; and
capturing a second image.

12. The method of claim 11, further comprising detecting that a shutter release button has been pressed before capturing said first image and capturing said second image, wherein said automatically focusing said imaging device is performed when said shutter release button has been pressed.

13. The method of claim 11, wherein said second image is captured after said predetermined period of time, further comprising again automatically focusing said imaging device before capturing said second image.

14. The method of claim 13, wherein said again automatically focusing said imaging device begins from a focus position left in said imaging device when said automatically focusing is ended after said predetermined period of time.

15. The method of claim 11, wherein said second image is captured during said predetermined period of time, further comprising terminating said continuing to automatically focus said imaging device before capturing said second image.

16. An apparatus for focusing an imaging device, comprising:
a. at least one computer readable medium; and
b. computer readable program code stored on said at least one computer readable medium, said computer readable program code comprising:
i. program code for capturing an image in said imaging device; and
ii. program code for continually automatically focusing said imaging device during a predetermined period of time after said capturing said image.

17. The apparatus of claim 16, further comprising program code for focusing said imaging device when a shutter release button is pressed on said imaging device to capture an image.

18. The apparatus of claim 17, wherein said program code for focusing said imaging device comprises program code for beginning a focus search from a default focus position.

19. The apparatus of claim 18, wherein said program code for focusing said imaging device further comprises program code for beginning said focus search from a previous focus position left by said continually automatically focusing during a predetermined period of time.

20. The apparatus of claim 19, wherein said program code for beginning said focus search from a previous focus position is executed when said shutter release button is pressed on said imaging device within a second predetermined period of time after said predetermined period of time after capturing said image.

21. The apparatus of claim 16, further comprising program code for terminating said continually automatically focusing when a shutter release button is pressed to capture a second image during said predetermined period of time.

22. An imaging apparatus, comprising:
a lens system;
a focus motor connected to said lens system for automatically focusing said lens system;
a control system connected to said focus motor, said control system being adapted to automatically adjust said focus motor to maintain a focused condition for a predetermined period after an image is captured by said imaging device.

23. An imaging apparatus, comprising:
means for capturing an image;
means for continuously automatically focusing said imaging apparatus; and
means for activating said continuously automatically focusing means for a predetermined period of time after said capturing means captures said image.
